(19) United States
(12) Patent Application Publication
(10) Pub. No.: US 2020/0130264 A1
(43) Pub. Date: Apr. 30, 2020

(54) ADDITIVE MANUFACTURING APPARATUS, ADDITIVE MANUFACTURING METHOD, AND COMPUTER PROGRAM PRODUCT

(71) Applicant: Toshiba Kikai Kabushiki Kaisha, Chiyoda-ku (JP)

(72) Inventors: Yasushi FUKASE, Numazu (JP); Shimpei FUJIMAKI, Mishima (JP); Hisanori FUWA, Numazu (JP); Shogo TANIGAKI, Numazu (JP)

(73) Assignee: Toshiba Kikai Kabushiki Kaisha, Chiyoda-ku (JP)

(21) Appl. No.: 16/658,843

(22) Filed: Oct. 21, 2019

(30) Foreign Application Priority Data
Oct. 29, 2018 (JP) 2018-203303

(51) Int. Cl. B29C 64/153; B29C 64/245; B29C 64/209; B29C 64/264; B29C 64/393

(52) U.S. Cl. CPC B29C 64/153; B29C 64/245; B33Y 10/00; B29C 64/264; B29C 64/393; B29C 64/209

(57) ABSTRACT

An additive manufacturing apparatus according to one embodiment includes a support surface, a manufacturing unit, and a control unit. The support surface can support an object that is additively manufactured. The manufacturing unit includes a nozzle that moves relative to the support surface, ejects powder, and outputs an energy ray to melt or sinter the powder, thereby forming a layer of the object. The manufacturing unit can change the orientation of the nozzle. The control unit can change a layer forming condition for the nozzle in accordance with a change in the orientation of the nozzle.

### CROSS-REFERENCE TO RELATED APPLICATIONS

This application is based upon and claims the benefit of priority from Japanese Patent Application No. 2018-203303, filed Oct. 29, 2018, the entire contents of which are incorporated herein by reference.

### FIELD

Embodiments described herein relate generally to an additive manufacturing apparatus, an additive manufacturing method, and a computer program product.

### BACKGROUND

Additive manufacturing apparatuses are known, which supply powdery material and output laser light from a nozzle to solidify the material, and form layers of the solidified material (e.g., Japanese Laid-open Patent Publication No. 2015-085547). The additive manufacturing apparatuses add a layer upon a layer of the solidified material, thereby additively manufacturing a three-dimensional object. The additive manufacturing apparatuses can additively manufacture objects having various shapes by changing the orientation of the nozzle, for example.

The orientation of the nozzle may incline with respect to the normal direction of a processing reference plane, causing a change in layer thickness in the normal direction of the processing reference plane. In such a case, shape error may occur in the object.

### SUMMARY

According to one embodiment, an additive manufacturing apparatus includes a support surface, a manufacturing unit and a control unit. The support surface supports an object. The manufacturing unit includes a nozzle being changeable in orientation, the nozzle configured to move relative to the support surface, eject powder, and output an energy ray to melt or sinter the powder, thereby forming a layer of the object. The control unit changes a layer forming condition for the nozzle in accordance with a change in the orientation of the nozzle.

### BRIEF DESCRIPTION OF THE DRAWINGS

FIG. 1 is an exemplary perspective view schematically illustrating an additive manufacturing apparatus according to a first embodiment;

FIG. 2 is an exemplary sectional view schematically illustrating part of the additive manufacturing apparatus and an object according to the first embodiment;

FIG. 3 is an exemplary block diagram functionally illustrating the configuration of the additive manufacturing apparatus according to the first embodiment;

FIG. 4 is an exemplary view schematically illustrating the object and a nozzle according to the first embodiment;

FIG. 5 is an exemplary view schematically illustrating the relation between the inclination angle of the nozzle and the thickness of a layer according to the first embodiment;

FIG. 6 is an exemplary flowchart of a procedure of additive manufacturing of the object by the additive manufacturing apparatus according to the first embodiment;

FIG. 7 is an exemplary block diagram functionally illustrating the configuration of the additive manufacturing apparatus according to a second embodiment;

FIG. 8 is an exemplary flowchart of a procedure of additive manufacturing of the object by the additive manufacturing apparatus according to the second embodiment;

FIG. 9 is an exemplary block diagram functionally illustrating the configuration of the additive manufacturing apparatus and an external computer according to a third embodiment; and

FIG. 10 is an exemplary flowchart of a procedure of changing a layer forming condition in an NC program by the external computer according to the third embodiment.

### DETAILED DESCRIPTION

### First Embodiment

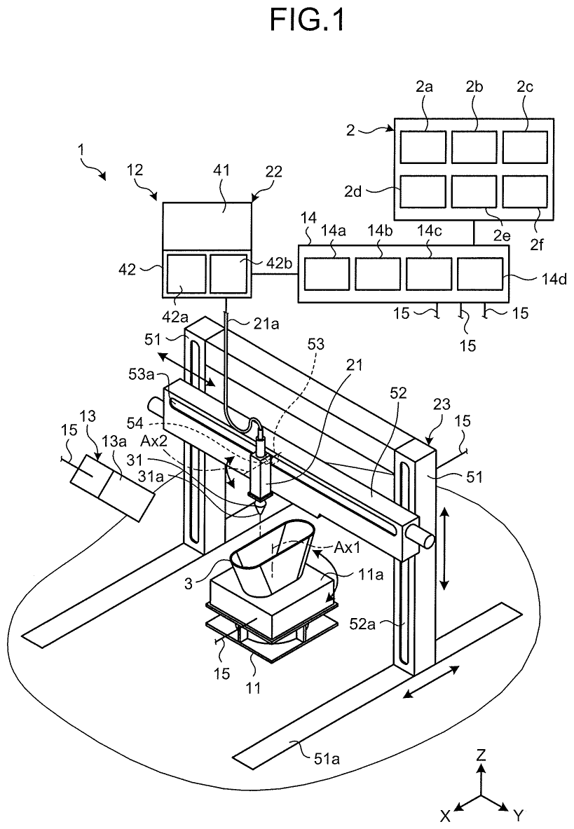

A first embodiment is described below with reference to FIGS. 1 to 6. In the present specification, the upper side in the vertical direction is referred to as an upper direction, and the lower side in the vertical direction is referred to as a lower direction. In the present specification, components according to the embodiment and explanation of the components may possibly be described in a plurality of representations. The components and the explanation thereof are given by way of example only and are not limited by the representations in the present specification. The components may be identified by names different from those in the present specification. The components may be explained by representations different from those in the present specification.

FIG. 1 is an exemplary perspective view schematically illustrating an additive manufacturing apparatus 1 according to the first embodiment. The additive manufacturing apparatus 1 is what is called a three-dimensional printer with a laser material deposition system. The additive manufacturing apparatus 1 is not limited to this example.

In the present specification, an X-axis, a Y-axis, and a Z-axis are defined as illustrated in the drawings. The X-axis, the Y-axis, and the Z-axis are orthogonal to one another. The Z-axis extends in the vertical direction, for example. The X-axis and the Y-axis extend in the horizontal direction, for example. The additive manufacturing apparatus 1 may be disposed with the Z-axis obliquely intersecting the vertical direction.

The additive manufacturing apparatus 1 is connected to an external computer 2 in a communicable manner by wire or wirelessly, for example. Examples of the external computer 2 include, but are not limited to, a personal computer, a server, a tablet terminal, a personal digital assistant (PDA), another computer, etc.

The external computer 2 includes a central processing unit (CPU) 2a, a read only memory (ROM) 2b, a random access memory (RAM) 2c, a storage 2d, an input device 2e, and an output device 2f, for example. The CPU 2a controls the external computer 2 and the additive manufacturing apparatus 1 connected thereto by executing computer programs installed in the ROM 2b or the storage 2d. The ROM 2b stores therein computer programs and data required to execute the computer programs. The RAM 2c functions as a work area in execution of the computer programs. The storage 2d is a device, such as a hard disk drive (HDD) and a solid state drive (SSD), that can store, change, and delete data. The input device 2e is various input devices, such as a keyboard, a mouse, or a touch panel. The output device 2f is various output devices, such as a display or a speaker.

The additive manufacturing apparatus 1 acquires a numerical control (NC) program for additive manufacturing from the external computer 2, for example. The additive manufacturing apparatus 1 is not limited to this example. The additive manufacturing apparatus 1 may acquire the NC program from an information storage medium, such as a memory card, or read it from a storage device included in the additive manufacturing apparatus 1.

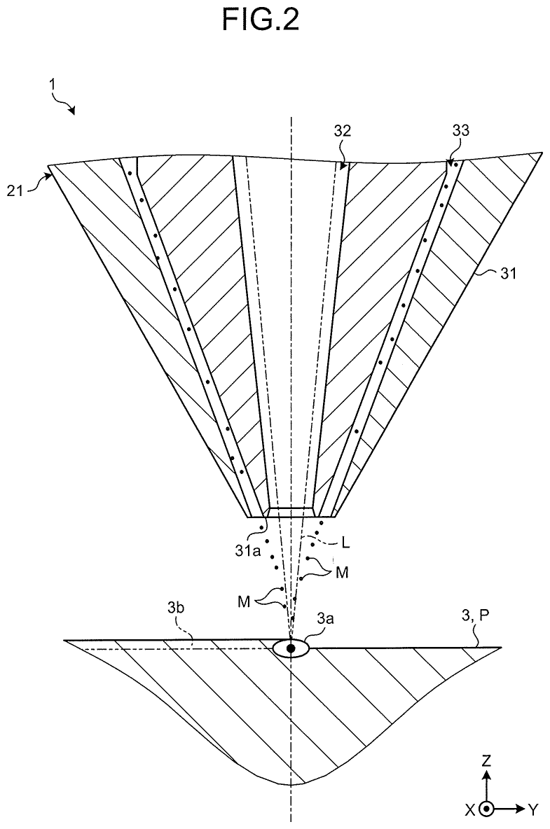

FIG. 2 is an exemplary sectional view schematically illustrating part of the additive manufacturing apparatus 1 and an object 3 according to the first embodiment. The additive manufacturing apparatus 1 adds a layer upon a layer of powdery material M, for example, thereby additively manufacturing the object 3 having a given shape. The material M is an example of powder. The object 3 is an example of an additively manufactured object.

As illustrated in FIG. 1, the additive manufacturing apparatus 1 includes a table 11, a manufacturing unit 12, a measuring unit 13, a control unit 14, and a plurality of signal lines 15. The table 11, the manufacturing unit 12, the measuring unit 13, and the control unit 14 are covered with a housing of the additive manufacturing apparatus 1 or disposed in a manufacturing room, for example.

The table 11 has a support surface 11a. The support surface 11a has a substantially flat shape and faces in the direction of the Z-axis (direction indicated by the arrow of the Z-axis or upward). The support surface 11a supports a finished object 3, an object 3 in progress, or a base on which the material M is layered. In the following description, the object 3 includes the finished object 3, the object in progress 3, and the base. Upon completion of additive manufacturing, the part of the object 3, i.e., the layers of the material M are integrated with the base. According to the present embodiment, the support surface 11a serves as a processing reference plane for additive manufacturing of the object 3. Alternatively, the surface of the base may serve as the processing reference plane.

At least part of the table 11 rotates, thereby rotating the object 3 supported by the support surface 11a about a first center of rotation Ax1. The first center of rotation Ax1 extends in the vertical direction (Z-axis direction).

The table 11 may move the object 3 in the X-axis, the Y-axis, and the Z-axis directions. Furthermore, the table 11 may rotate the object 3 about a center of rotation extending in the Y-axis direction and a center of rotation extending in the X-axis direction.

The manufacturing unit 12 supplies and layers the material M on the support surface 11a or the base supported by the support surface 11a. The material M is a powdered metal, for example. The material M is not limited thereto and may be other materials, such as synthetic resin and ceramic. The additive manufacturing apparatus 1 may additively manufacture the object 3 from a plurality of kinds of materials M.

The manufacturing unit 12 includes a nozzle 21, a supply device 22, and a movement device 23. The nozzle 21 ejects the material M to the support surface 11a of the table 11 or the object 3 on the support surface 11a. As illustrated in FIG. 2, the nozzle 21 outputs laser light L to the ejected material M or the object 3 on the support surface 11a. The laser light L is an example of an energy ray.

The nozzle 21 outputs the laser light L concurrently with supplying the material M. The nozzle 21 may output other energy rays in addition to or instead of the laser light L. The energy ray may be any desired ray that can melt or sinter the material M like the laser light L and may be an electron beam, microwaves, or electromagnetic waves in the ultraviolet range, for example.

The manufacturing unit 12 heats the base or the ejected material M by the laser light L, thereby forming a melting region (bead) 3a. In the melting region 3a, the laser light L melts or sinters the material M to aggregate it. As described above, the melting region 3a can include not only the supplied material M but also part of the base or the object 3 irradiated with the laser light L. The melting region 3a is not limited to completely melted material M and may be a combination of partially melted material M.

By solidifying the melting region 3a, a layer 3b serving as an aggregate of the material M having a layer- or a film-like shape, for example, is formed on the base or the object 3. The material M may be cooled by heat transfer to the aggregate of the material M, thereby being layered in a granular form and formed into a granular aggregate (layer).

The manufacturing unit 12 may perform annealing by outputting the laser light L to the aggregate of the material M from the nozzle 21. The aggregate of the material M is re-melted or re-sintered by the laser light L and then solidified, thereby being formed into the layer 3b.

The manufacturing unit 12 additively manufactures the object 3 by repeatedly forming the layers 3b. The layers 3b are part of the object 3. The layers 3b are included in the object 3. As described above, the nozzle 21 of the manufacturing unit 12 outputs the laser light L to melt or sinter the material M, to form the layers 3b. The manufacturing unit 12 repeatedly forms the layers 3b, thereby additively manufacturing the object 3 on the support surface 11a.

The nozzle 21 includes a nozzle head 31. An end 31a of the nozzle head 31 faces the object 3 with a gap. The nozzle head 31 is provided with an output passage 32 and a discharge passage 33. The output passage 32 and the discharge passage 33 open to the end 31a, for example.

The output passage 32 is a hole having a substantially circular section. The laser light L passes through the output passage 32 and is output to the outside of the nozzle head 31. The discharge passage 33 is a hole having a substantially annular section and surrounds the output passage 32. Carrier gas and the material M pass through the discharge passage 33 and are ejected to the outside of the nozzle head 31.

As illustrated in FIG. 1, the supply device 22 includes an optical device 41 and a material supply device 42. The optical device 41 includes a light source and an optical system, for example. The light source includes an oscillator and outputs the laser light L by oscillation of the oscillator. The light source can change the output (power) of the output laser light L.

The light source causes the output laser light L to enter into the optical system. The laser light L enters into the nozzle 21 via the optical system. The optical system can change the focal diameter of the laser light L. The optical device 41 supplies the laser light L to the output passage 32 of the nozzle 21 and outputs the laser light L from the output passage 32.

The nozzle 21 irradiates and heats the ejected material M with the laser light L, thereby forming and annealing the layer 3b of the material M. Furthermore, the nozzle 21 irradiates the object 3 with the laser light L, thereby removing an unnecessary part from the object 3.

The material supply device 42 includes a material supply unit 42a and a tank 42b. The tank 42b accommodates the material M. The material supply device 42 may include a plurality of tanks 42b that accommodate different kinds of materials M.

The material supply unit 42a supplies the material M in the tank 42b to the nozzle 21 via a supply pipe 21a. The material supply unit 42a supplies the material M to the nozzle 21 with carrier gas, for example. The carrier gas is inert gas, such as nitrogen and argon.

The material supply unit 42a supplies the carrier gas and the material M to the discharge passage 33 of the nozzle head 31 via the supply pipe 21a. As a result, the nozzle 21 ejects the carrier gas and the material M from the discharge passage 33. The material supply unit 42a can change the amount of the material M ejected from the nozzle 21 per unit time and the speed of the ejected material M.

The material supply unit 42a includes a tank that accommodates the carrier gas, a compressor that causes the carrier gas in the tank to flow into the supply pipe 21a, and a device that supplies the material M in the tank 42b to the flow of the carrier gas, for example. The material supply unit 42a may supply the material M to the nozzle 21 by other means.

The supply device 22 may also supply purge gas and shield gas to the nozzle 21 via the supply pipe 21a. The purge gas and the shield gas are inert gas, such as nitrogen and argon. The supply pipe 21a includes a pipe through which the carrier gas and the material M pass, a pipe through which the purge gas passes, a pipe through which the shield gas passes, and a cable through the laser light L passes.

The movement device 23 moves and rotates the nozzle 21. The movement device 23 includes a pair of columns 51, a cross rail 52, a movable element 53, and a rotation mechanism 54. The movement device 23 is not limited to this example and may be other devices, such as an articulated robot arm, that can move and rotate the nozzle 21.

The columns 51 serving as a pair are separated from each other in the Y-axis direction and extend in the Z-axis direction. The table 11 is positioned between the pair of columns 51 in the Y-axis direction. The columns 51 can move in the X-axis direction with respect to the table 11 by movement mechanisms 51a provided to the respective columns 51 and the floor, for example.

The movement mechanisms 51a each include various parts, such as an actuator provided in the corresponding column 51 and a rail provided on the floor and extending in the X-axis direction, that move the corresponding column 51 in the X-axis direction. The columns 51 serving as a pair are coupled to each other and can move in parallel with the X-axis direction.

The cross rail 52 extends in the Y-axis direction substantially linearly. Both ends of the cross rail 52 are supported by the pair of columns 51. In other words, the cross rail 52 is connected to the columns 51. The cross rail 52 can move in the Z-axis direction with respect to the columns 51 by movement mechanisms 52a provided to the respective columns 51 and the cross rail 52, for example.

The movement mechanisms 52a each include various parts, such as a ball screw and an actuator provided in the corresponding column 51, that move the cross rail 52 in the Z-axis direction. The cross rail 52 extends in the Y-axis direction and can move in parallel with the Z-axis direction. In other words, the cross rail 52 moves along the columns 51.

The movable element 53 can move in the Y-axis direction with respect to the cross rail 52 by a movement mechanism 53a provided to the cross rail 52, for example. As described above, the moving direction of the movable element 53 is orthogonal to the moving direction of the columns 51 and the cross rail 52.

The movement mechanism 53a includes various parts, such as a ball screw and an actuator provided in the cross rail 52, that move the movable element 53. The movable element 53 is a nut of the ball screw disposed in the cross rail 52, for example. The movable element 53 is connected to the movement mechanism 53a of the cross rail 52. The movable element 53 is moved along the cross rail 52 by the movement mechanism 53a.

The nozzle 21 is connected to the movable element 53. The rotation mechanism 54 rotates the nozzle 21 about a second center of rotation Ax2 with respect to the movable element 53. The second center of rotation Ax2 extends in the X-axis direction. The rotation mechanism 54 includes various parts, such as an actuator provided in the nozzle 21, that rotate the nozzle 21.

As described above, the movement device 23 can move the nozzle 21 relative to the support surface 11a and can change the orientation of the nozzle 21. According to the present embodiment, the orientation of the nozzle 21 is set for ejecting the material M and outputting the laser light L. The movement device 23 can change the movement speed of the nozzle 21 with respect to the support surface 11a. By moving and rotating the table 11, the nozzle 21 may be moved relative to the support surface 11a and changed in orientation with respect to the support surface 11a.

The measuring unit 13 measures the shapes of the object 3 and the layer 3b of the object 3 supported by the support surface 11a of the table 11. The measuring unit 13 includes a camera 13a, for example. The measuring unit 13 is not limited to this example and may include other devices, such as a laser measuring device, that can measure the shape of the layer 3b. The measuring unit 13 may also include an image processing device that processes information on the measured shapes of the object 3 and the layer 3b.

The control unit 14 is electrically connected to the table 11, the manufacturing unit 12, and the measuring unit 13 via the signal lines 15. The control unit 14 includes a CPU 14a, a ROM 14b, a RAM 14c, and a storage 14d, for example. The control unit 14 may also include an input device, such as a keyboard and a mouse, and an output device, such as a display and a speaker.

The control unit 14 controls the units of the additive manufacturing apparatus 1 by the CPU 14a executing computer programs installed in the ROM 14b or the storage 14d. The control unit 14 controls the nozzle 21, the optical device 41, the material supply device 42, and the movement device 23 of the manufacturing unit 12, for example.

The ROM 14b stores therein computer programs and data required to execute the computer programs. The RAM 14c functions as a work area in execution of the computer programs. The storage 14d is a device, such as an HDD and an SSD, that can store, change, and delete data.

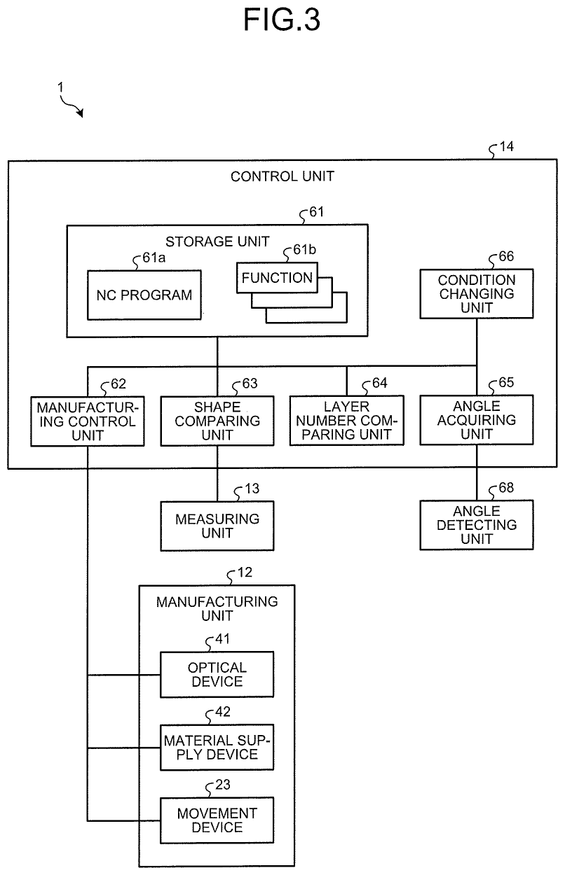

FIG. 3 is an exemplary block diagram functionally illustrating the configuration of the additive manufacturing apparatus 1 according to the first embodiment. The control unit 14 loads the units illustrated in FIG. 3 by the CPU 14a reading and executing the computer programs stored in the ROM 14b or the storage 14d, for example. As illustrated in FIG. 3, the control unit 14 includes a storage unit 61, a manufacturing control unit 62, a shape comparing unit 63, a layer number comparing unit 64, an angle acquiring unit 65, and a condition changing unit 66, for example.

The storage unit 61 is included in the RAM 14c or the storage 14d, for example. The storage unit 61 stores therein various kinds of information including an NC program 61a. The NC program 61a is an example of numerical control information.

The NC program 61a includes manufacturing information of the layers 3b and the object 3 including the layers 3b. Examples of the information contained in the NC program 61a include the shapes of the object 3 and the layers 3b, the movement path of the nozzle 21, and various data acquired at each position on the movement path, such as the movement speed and the orientation of the nozzle 21, the amount of the material M ejected per unit time, the speed of the ejected material M, the output of the laser light L, and the focal diameter of the laser light L. The NC program 61a may also include other information.

The manufacturing control unit 62 controls the manufacturing unit 12 including the movement device 23, the optical device 41, and the material supply device 42 based on the NC program 61a to manufacture a plurality of layers 3b (object 3). The shape comparing unit 63 compares the result of measurement of the shape of the layers 3b (object 3) by the measuring unit 13 (hereinafter, referred to as a measured shape) with the shape of the layers 3b (object 3) in the NC program 61a or CAD serving as the basis of the NC program 61a (hereinafter, referred to as a model shape).

The layer number comparing unit 64 compares the number of formed layers 3b with a threshold. The angle acquiring unit 65 detects the orientation of the nozzle 21 with an angle detecting unit 68. The angle detecting unit 68 is a rotation angle sensor, such as a rotary encoder, and included in the nozzle 21 or the movement device 23.

The condition changing unit 66 can change the information on the data acquired at the positions on the movement path in the NC program 61a, that is, the movement speed of the nozzle 21, the amount of the material M ejected per unit time, the output of the output laser light L, the focal diameter of the output laser light L, and the relative position of the nozzle 21 with respect to the support surface 11a.

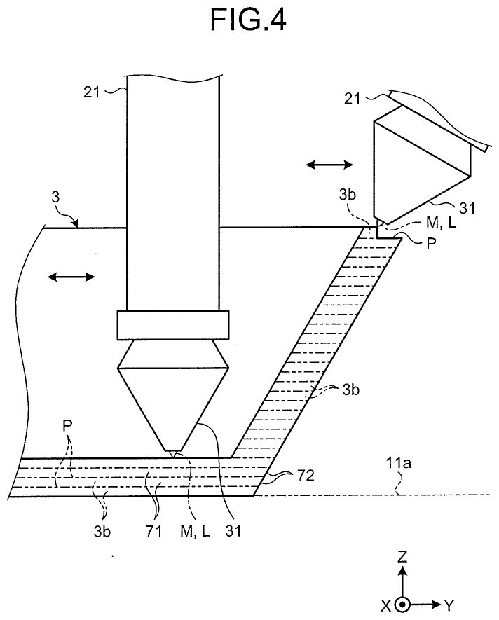

FIG. 4 is an exemplary view schematically illustrating the object 3 and the nozzle 21 according to the first embodiment. FIG. 4 illustrates a section of the object 3 and indicates the boundaries of the layers 3b by the alternate long and two short dashes lines instead of hatching.

As illustrated in FIG. 4, the layers 3b each include a vertical supported part 71 and a non-vertical supported part 72. The vertical supported part 71 is part of the layer 3b supported by the layer 3b below or the support surface 11a in the normal direction of the support surface 11a. The non-vertical supported part 72 is part of the layer 3b not supported in the normal direction of the support surface 11a and expands from the vertical supported part 71 in a direction intersecting the normal direction of the support surface 11a.

To form the vertical supported part 71 of the layer 3b, the nozzle 21 faces downward in the vertical direction. In other words, the nozzle 21 faces in the normal direction of the support surface 11a. To form the non-vertical supported part 72 of the layer 3b, the nozzle 21 faces in a direction intersecting the normal direction of the support surface 11a. To form the vertical supported part 71, the nozzle 21 may face in a direction intersecting the normal direction of the support surface 11a.

With the nozzle 21 facing in a direction intersecting the normal direction of the support surface 11a, the non-vertical supported part 72 can be formed with no jig or support. Furthermore, with the nozzle 21 facing in a direction intersecting the normal direction of the support surface 11a, the non-vertical supported parts 72 need not be formed stepwise, thereby making the surface of the object 3 relatively smooth. Consequently, the additive manufacturing apparatus 1 of the present embodiment can decrease processing time for smoothen the surface of the object 3 and an amount of the material M used.

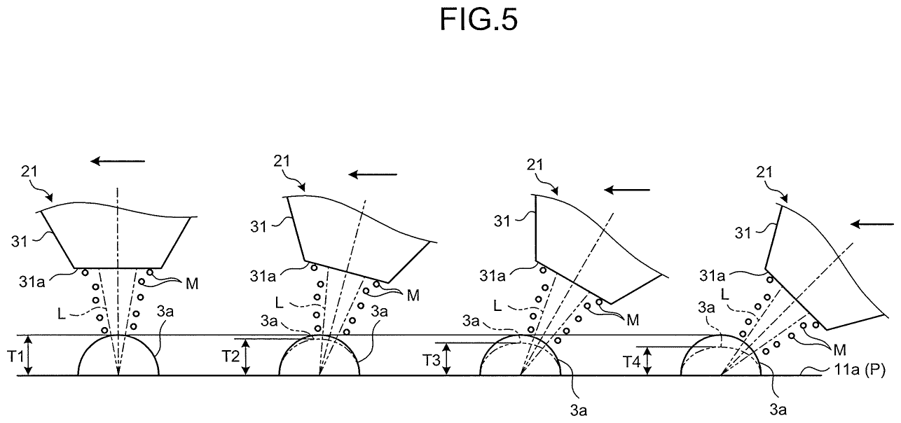

FIG. 5 is an exemplary view schematically illustrating the relation between the inclination angle of the nozzle 21 and the thickness of the layer 3b according to the first embodiment. FIG. 5 illustrates the nozzle 21 facing in various directions and the melting region 3a formed by the nozzle 21. While the melting region 3a illustrated in FIG. 5 schematically has a symmetrical shape, it can have an asymmetrical shape protruding toward the nozzle 21.

As illustrated in FIG. 5, the control unit 14 according to the present embodiment controls the manufacturing unit 12 such that the thickness of the melting region 3a in the normal direction of the support surface 11a is a given thickness T1 independently of the inclination angle of the orientation of the nozzle 21 (hereinafter, referred to as the inclination angle of the nozzle 21) with respect to the normal direction of the support surface 11a. Specifically, the condition changing unit 66 changes the NC program 61a such that the melting region 3a has the given thickness T1. The thickness of the melting region 3a is substantially equal to that of the layer 3b.

FIG. 5 indicates a comparative example of the melting region 3a obtained when the condition changing unit 66 does not change the NC program 61a by the alternate long and two short dashes lines. In the comparative example, as the inclination angle of the nozzle 21 increases, the thickness of the melting region 3a decreases. While the volume of the melting region 3a schematically decreases in FIG. 5, it can be fixed independently of the inclination angle of the nozzle 21.

A thickness T2 of the melting region 3a obtained when the inclination angle of the nozzle 21 is 15°, for example, is 0.9 times the thickness T1. A thickness T3 of the melting region 3a obtained when the inclination angle of the nozzle 21 is 30° is 0.8 times the thickness T1. A thickness T4 of the melting region 3a obtained when the inclination angle of the nozzle 21 is 45° is 0.7 times the thickness T1. The ratios of the thicknesses T2 to T4 to the thickness T1 are given by way of example for explanation.

The melting region 3a (layer 3b) according to the present embodiment is formed to have the substantially equal thickness T1. As a result, as illustrated in FIG. 4, the object 3 is additively manufactured such that layered planes P of the respective layers 3b are substantially parallel to the support surface 11a. The layered plane P is the surface of the layer 3b, and the next layer 3b is layered on the layered plane P.

The following describes additive manufacturing of the object 3 by the additive manufacturing apparatus 1 according to the present embodiment in greater detail. The method for additive manufacturing of the object 3 by the additive manufacturing apparatus 1 is not limited to the method described below.

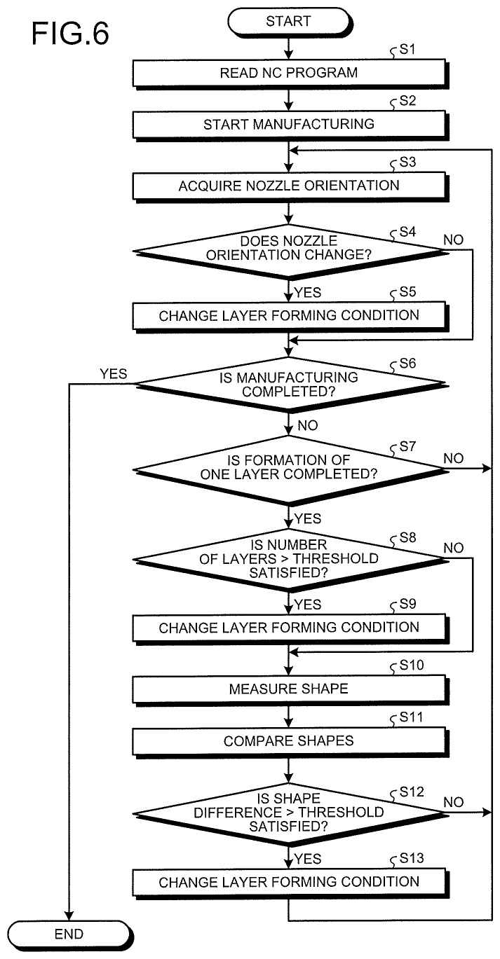

FIG. 6 is an exemplary flowchart of the procedure of additive manufacturing of the object 3 by the additive manufacturing apparatus 1 according to the first embodiment. As illustrated in FIG. 6, the NC program 61a is read from the storage unit 61 (S1).

The NC program 61a is input from the external computer 2, for example. The NC program 61a may be generated from CAD data by the control unit 14. The control unit 14, for example, divides a three-dimensional shape in CAD data into a plurality of layers (slicing). The control unit 14 converts the sliced three-dimensional shape into a group of a plurality of points or cuboids (pixels), for example (rasterization or pixelation). The control unit 14 automatically generates information on the movement path of the nozzle 21 to form a part corresponding to each pixel, the movement speed and the angle of the nozzle 21, the amount and the speed of the ejected material M, and the output and the focal diameter of the output laser light L. The control unit 14, for example, generates the NC program 61a based on required conditions, such as the type of the material M, surface roughness, and manufacturing time.

Subsequently, the manufacturing control unit 62 starts to manufacture the layer 3b based on the read NC program 61a (S2). The movement device 23 controlled by the manufacturing control unit 62, for example, starts to move and rotate the nozzle 21 with respect to the support surface 11a. In addition, the table 11 may start to rotate the object 3. The nozzle 21 controlled by the manufacturing control unit 62 starts to eject the material M and output the laser light L. As a result, the ejected material M is melted or sintered, and formed into the layer 3b.

Subsequently, the condition changing unit 66 acquires the orientation of the nozzle 21 from the angle acquiring unit 65 (S3). The condition changing unit 66 determines whether the orientation of the nozzle 21 has changed (S4). If the orientation of the nozzle 21 has changed (Yes at S4), the condition changing unit 66 changes a condition for forming the layer 3b (hereinafter, referred to as a layer forming condition) included in the NC program 61a, in accordance with the change in the orientation of the nozzle 21 (S5). In other words, the condition changing unit 66 changes the layer forming condition on the basis of a result of the detection of the change in the orientation of the nozzle 21. The condition for forming the layer 3b may also be referred to as the state, element, condition, factor, or parameter for forming the layer 3b, for example.

The layer forming condition represents a command value of the NC program 61a to be input to the manufacturing unit 12, for example. The layer forming condition includes at least one of the movement speed of the nozzle 21 with respect to the support surface 11a (hereinafter, referred to as nozzle movement speed), the amount of the material M ejected from the nozzle 21 per unit time (hereinafter, referred to as a material ejection amount), the output of the laser light L (hereinafter, referred to as laser output), the diameter of the focal point of the laser light L (hereinafter, referred to as a laser diameter), and the position of the nozzle 21 relative to the support surface 11a. The layer forming condition may include other conditions, such as the speed of the material M ejected from the nozzle 21.

The condition changing unit 66, for example, changes the nozzle movement speed based on a change in the orientation of the nozzle 21. The condition changing unit 66 reduces the nozzle movement speed as the inclination angle of the nozzle 21 increases.

Reduction in the nozzle movement speed increase the amount of the material M supplied to the melting region 3a, thereby increasing the thickness of the layer 3b in the normal direction of the support surface 11a. As a result, the thickness of the layer 3b in the normal direction of the support surface 11a is the given thickness T1 independently of the inclination angle of the nozzle 21.

When the inclination angle of the nozzle 21 changes from 0° to 15°, for example, the nozzle movement speed is reduced to 0.9 times, thereby increasing the thickness of the layer 3b from the thickness T2 to the thickness T1. When the inclination angle of the nozzle 21 changes from 0° to 30°, the nozzle movement speed is reduced to 0.85 times, thereby increasing the thickness of the layer 3b from the thickness T3 to the thickness Tl. When the inclination angle of the nozzle 21 changes from 0° to 45°, the nozzle movement speed is reduced by 0.7 times, thereby increasing the thickness of the layer 3b from the thickness T4 to the thickness T1. The change ratios of the nozzle movement speed are given by way of example for explanation.

As described above, to deal with an increase in the inclination angle of the nozzle 21, the condition changing unit 66 changes the layer forming condition such that the nozzle 21 forms the layer 3b of an increased thickness in the normal direction of the support surface 11a from a thickness before changing the layer forming condition. In response to a change in another layer forming condition, the condition changing unit 66 changes the layer forming condition in the same manner.

The condition changing unit 66, for example, may increase the material ejection amount as the inclination angle of the nozzle 21 increases. In this case, the amount of the material M supplied to the melting region 3a increases, thereby increasing the thickness of the layer 3b.

The condition changing unit 66 may increase the laser output as the inclination angle of the nozzle 21 increases. Alternatively, the condition changing unit 66 may increase the laser diameter as the inclination angle of the nozzle 21 increases. In these cases, the ratio of the material M melted or sintered by the laser light L in the ejected material M increases, thereby increasing the thickness of the layer 3b.

In addition to changing the laser output or the laser diameter, the condition changing unit 66 may also change the material ejection amount. In other words, the condition changing unit 66 may change a plurality of layer forming conditions based on the change in the orientation of the nozzle 21.

The inclination angle of the nozzle 21 and the change amount of the layer forming condition are determined by a function (expression) 61b stored in the storage unit 61, for example. The function 61b changes the layer forming condition at a given ratio based on the change in the inclination angle of the nozzle 21 using an inclination angle of 0° (vertically downward) as a reference, for example.

The function 61b for causing the melting region 3a (layer 3b) to have the thickness T1 may possibly change based on the specifications of the additive manufacturing apparatus 1, the type and the granularity of the material M, and other various conditions, for example. Consequently, a plurality of functions 61b are determined in advance by polynomial approximation from data obtained by simulations and experiments, for example. The condition changing unit 66 selects the function 61b corresponding to the conditions from the functions 61b stored in the storage unit 61. The conditions may be included in the NC program 61a or input manually.

A unique layer forming condition may be set based on the inclination angle of the nozzle 21. The storage unit 61, for example, stores therein a table defining the layer forming condition corresponding to the inclination angle. The condition changing unit 66 can select the table corresponding to the conditions from a plurality of tables stored in the storage unit 61.

If the change amount of the inclination angle of the nozzle 21 is larger than a threshold, for example, the change amount of the layer forming condition at one time may be limited, and the layer forming condition may be changed a plurality of times. This mechanism can prevent the shape of the layered plane P of the layer 3b from being deformed by a sudden change in the layer forming condition.

If the orientation of the nozzle 21 has not changed (No at S4), the layer forming condition is not changed. Alternatively, if the orientation of the nozzle 21 has not changed, the layer forming condition may be changed by a change amount of 0.

Subsequently, the manufacturing control unit 62 determines whether manufacturing of the object 3 is completed (S6). If manufacturing of the object 3 is not completed yet (No at S6), the manufacturing control unit 62 determines whether formation of one layer is completed (S7). If formation of one layer 3b is not completed yet (No at S7), formation of the layer 3b is continued, and the condition changing unit 66 acquires the orientation of the nozzle 21 again (S3).

If formation of one layer 3b is completed (Yes at S7), the layer number comparing unit 64 determines whether the number of formed layers 3b is larger than a threshold (S8). The threshold is set to 20% and 80% of the total number of the layers 3b included in the NC program 61a, for example. The threshold is given by way of example only and is not limited to this example.

The change amount of the thickness of the layer 3b based on the inclination angle may possibly change depending on the progress of manufacturing, for example. To address this, the condition changing unit 66 according to the present embodiment changes the change amount of the layer forming condition based on the inclination angle of the nozzle 21 depending on early, middle, and final stages of the manufacturing process.

If the number of layers 3b is determined to be larger than 20% of the total number of the layers 3b (Yes at S8)in the middle stage, the condition changing unit 66 additionally changes the layer forming condition (S9). The condition changing unit 66 changes the function 61b, for example. The condition changing unit 66 may additionally change the contents of the layer forming condition. If the number of layers 3b is determined to be larger than 80% of the total number of the layers 3b in the final stage, the condition changing unit 66 additionally changes the layer forming condition. As described above, the condition changing unit 66 additionally changes the layer forming condition in accordance with the number of formed layers 3b. If the number of layers 3b is equal to or smaller than the threshold (No at S8), the condition changing unit 66 does not change the layer forming condition.

Subsequently, the measuring unit 13 measures the shape of the layers 3b (S10). Subsequently, the shape comparing unit 63 compares the measured shape with the model shape (S11). Subsequently, the shape comparing unit 63 determines whether difference in shape between the measured shape and the model shape is larger than a threshold (S12). The difference in shape is the difference between the thickness of the measured shape and that of the model shape in the normal direction of the support surface 11a, for example.

If the difference in shape is larger than the threshold (Yes at S12), the condition changing unit 66 further changes the layer forming condition (S13). The condition changing unit 66 changes the function 61b, for example. The condition changing unit 66 may additionally change the contents of the layer forming condition. As described above, the condition changing unit 66 additionally changes the layer forming condition on the basis of a result of the measurement by the measuring unit 13. By changing the layer forming condition, it is made possible to correct shape errors occurring in the layers 3b in actual manufacturing process.

In response to the change in the layer forming condition or if the difference in shape is equal to or smaller than the threshold (No at S12), the condition changing unit 66 acquires the orientation of the nozzle 21 from the angle acquiring unit 65 again (S3). The procedure (S3 to S13) described above is repeated until manufacturing of the object 3 is completed (Yes at S6). As described above, the additive manufacturing apparatus 1 adds the layers 3b on top of each other, thereby additively manufacturing the object 3.

In the additive manufacturing apparatus 1 according to the first embodiment, the manufacturing unit 12 can change the orientation of the nozzle 21. Typically, if the nozzle 21 changes in orientation and inclines at a larger angle with respect to the normal direction of the support surface 11a, to eject the material M, the layer 3b will be formed in decreased thickness per unit time in the normal direction of the support surface 11a. To address this, the control unit 14 according to the present embodiment can change the layer forming condition for the nozzle 21 in accordance with the change in the orientation of the nozzle 21. As a result, the control unit 14 can change the layer forming condition for the nozzle 21 such that the nozzle 21 can form the layers 3b of substantially uniform thickness in the normal direction of the support surface 11a, for example. Consequently, the additive manufacturing apparatus 1 can additively manufacture the object 3 having a shape closer to a desired shape, such as the model shape.

The layer forming condition includes at least one of the nozzle movement speed, the material ejection amount, the laser output, and the laser diameter. As the inclination angle of the nozzle 21 increases, the control unit 14 reduces the nozzle movement speed, increases the material ejection amount, increases the laser output, or increases the laser diameter, for example. This makes it possible to form the layers 3b of substantially uniform thickness in the normal direction of the support surface 11a, for example. Consequently, the additive manufacturing apparatus 1 can additively manufacture the object 3 having a shape closer to a desired shape.

In response to an increase in the inclination angle of the nozzle 21, the control unit 14 changes the layer forming condition such that the nozzle 21 forms the layer 3b of an increased thickness in the normal direction of the support surface 11a from a thickness before changing the layer forming condition. As a result, the control unit 14 can change the layer forming condition for the nozzle 21 so as to form the layers 3b of substantially uniform thickness in the normal direction of the support surface 11a, for example. Consequently, the additive manufacturing apparatus 1 can additively manufacture the object 3 having a shape closer to a desired shape.

Along with the addition of the layers 3b formed by the nozzle 21, shape errors in the layers 3b may be accumulated. To address this, the control unit 14 according to the present embodiment can change the layer forming condition in accordance with the number of formed layers 3b. A larger number of layers formed 3b is likely to contain larger shape errors, for example. In view of this, the control unit 14 changes the degree of change in the layer forming condition. As a result, the control unit 14 can change the layer forming condition for the nozzle 21 so as to form the layers 3b of substantially uniform thickness in the normal direction of the support surface 11a, for example. Consequently, the additive manufacturing apparatus 1 can additively manufacture the object 3 having a shape closer to a desired shape.

The measuring unit 13 measures the shape of the layer 3b. The control unit 14 can additionally change the layer forming condition on the basis of the result of measurement by the measuring unit 13. If the measured shape of the layer 3b is different from a desired shape of the layer 3b, for example, the control unit 14 changes the degree of changing the layer forming condition. As a result, the control unit 14 can change the layer forming condition for the nozzle 21 so as to form the layers 3b of substantially uniform thickness in the normal direction of the support surface 11a, for example. Consequently, the additive manufacturing apparatus 1 can additively manufacture the object 3 having a shape closer to a desired shape.

The control unit 14 changes the layer forming condition on the basis of the result of detection of a change in the orientation of the nozzle 21. As a result, the layer forming condition can be changed in accordance with the actual orientation of the nozzle 21, thereby enabling the nozzle 21 to form the layers 3b more accurately. Consequently, the additive manufacturing apparatus 1 can additively manufacture the object 3 having a shape closer to a desired shape.

### Second Embodiment

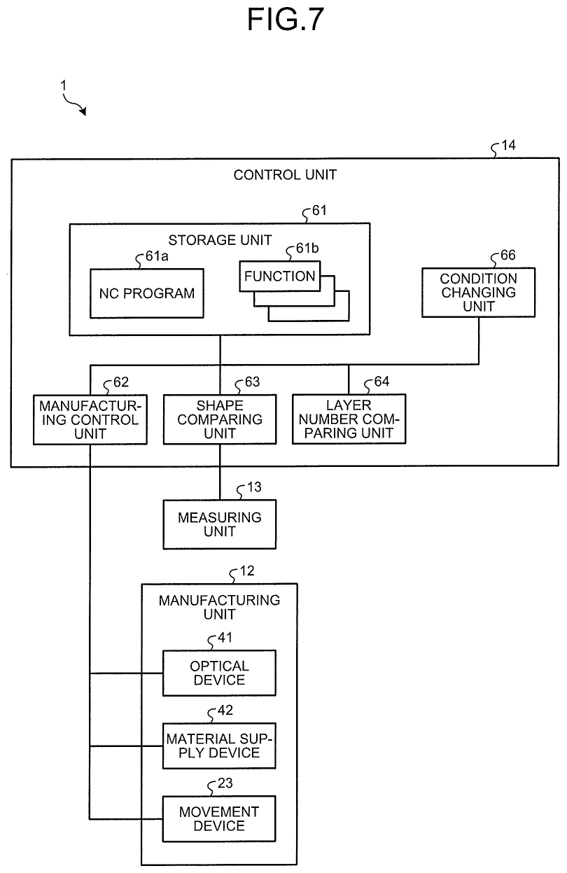

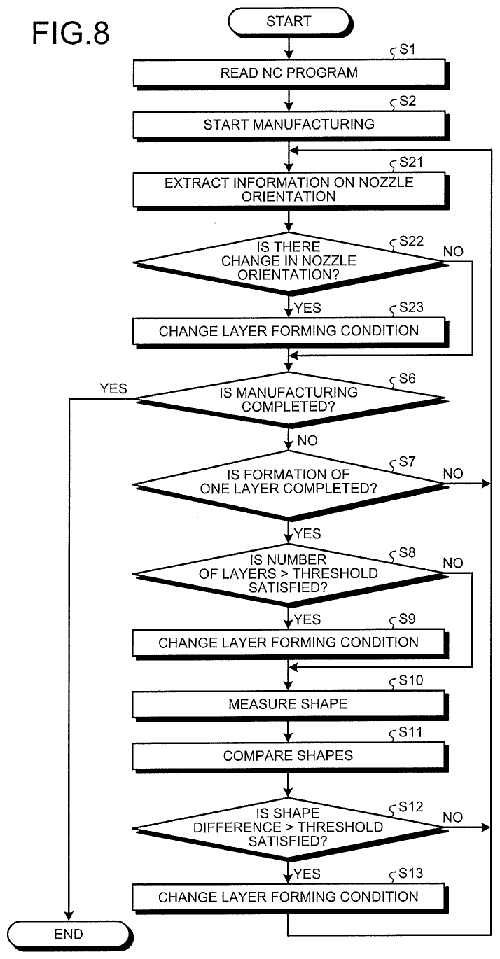

A second embodiment is described below with reference to FIGS. 7 and 8. In the explanation of a plurality of embodiments below, components having the same functions as those of the already described components are denoted by like reference numerals, and explanation thereof may be omitted. All the functions and characteristics of a plurality of components denoted by like reference numerals are not necessarily the same, and the components may have different functions and characteristics corresponding to the embodiments.

FIG. 7 is an exemplary block diagram functionally illustrating the configuration of the additive manufacturing apparatus 1 according to the second embodiment. As illustrated in FIG. 7, the second embodiment does not include the angle acquiring unit 65 or the angle detecting unit 68 according to the first embodiment.

FIG. 8 is an exemplary flowchart of the additive manufacturing procedure of the object 3 by the additive manufacturing apparatus 1 according to the second embodiment. In the second embodiment, as illustrated in FIG. 8, the NC program 61a is read from the storage unit 61 (S1), and the manufacturing control unit 62 starts forming the layer 3b (S2). The condition changing unit 66 extracts information on the orientation of the nozzle 21 from the NC program 61a (S21). The information on the orientation of the nozzle 21 includes a command value of the NC program 61a to be input to the manufacturing unit 12 and indicates the inclination angle of the nozzle 21 at each position on the movement path of the nozzle 21.

Subsequently, the condition changing unit 66 determines whether the information on the orientation of the nozzle 21 changes (S22). The condition changing unit 66, for example, determines whether the orientation of the nozzle 21 changes at the next position on the movement path of the nozzle 21. The timing of the determination is not limited to this example. The condition changing unit 66, for example, may determine a change in the orientation of the nozzle 21 at the present position or at a position where the nozzle 21 is to be disposed in n seconds.

In response to a change in the information on the orientation of the nozzle 21 (Yes at S22), the condition changing unit 66 changes the layer forming condition in accordance with the change in the orientation of the nozzle 21 (S23), as with the processing (S5) in the first embodiment. As described above, the condition changing unit 66 changes the layer forming condition on the basis of the information on the orientation of the nozzle 21. With no change in the information on the orientation of the nozzle 21 (No at S22), the condition changing unit 66 does not change the layer forming condition.

The material ejection amount may be changed at the time of changing the layer forming condition (S23). In this case, it may possibly take a time from when an instruction to change the material ejection amount is given to when the material ejection amount is actually changed because the supply pipe 21a has a long length. Considering the time lag, the present embodiment gives an instruction to change the material ejection amount before the orientation of the nozzle 21 is changed. With this mechanism, the present embodiment can change the material ejection amount simultaneously with changing the orientation of the nozzle 21.

Not only in changing the material ejection amount described above but also in changing the nozzle movement speed, it may possibly take a long time from when an instruction to change the nozzle movement speed is given to when the nozzle movement speed is actually changed. Considering the time lag, the present embodiment may determine whether to change the nozzle movement speed in advance. The timings of determining the orientation of the nozzle 21 (S22) and changing the layer forming condition (S23) can be calculated by experiments and simulations, for example.

The procedure (S6 to S13) similar to that according to the first embodiment is performed, and the process is returned to extracting the information on the orientation of the nozzle 21 (S21). The procedure (S21 to S13) described above is repeated until manufacturing of the object 3 is completed (Yes at S6). As described above, the additive manufacturing apparatus 1 adds the layers 3b on top of each other, thereby additively manufacturing the object 3.

The additive manufacturing apparatus 1 according to the second embodiment extracts the information on the orientation of the nozzle 21 from the NC program 61a for forming the layers 3b. According to the information on the orientation of the nozzle 21, the additive manufacturing apparatus 1 changes the layer forming condition. Thereby, the additive manufacturing apparatus 1 can determine to change the layer forming condition before the orientation of the nozzle 21 is actually changed. Under the changed layer forming condition, the nozzle 21 can form the layers 3b more accurately. Consequently, the additive manufacturing apparatus 1 can additively manufacture the object 3 having a shape closer to the desired shape.

### Third Embodiment

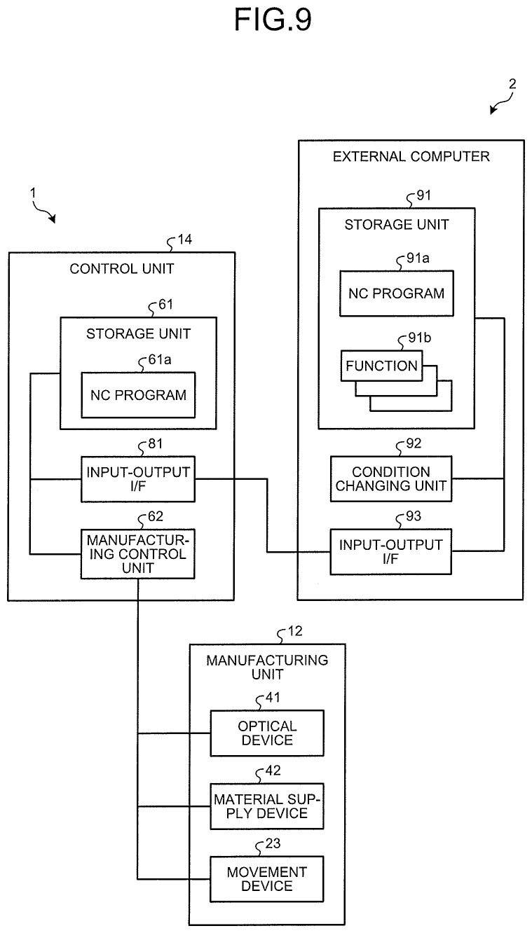

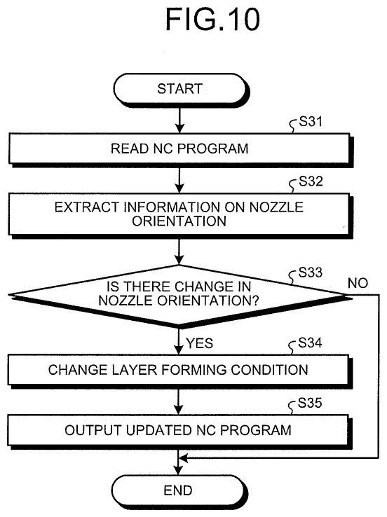

A third embodiment is described below with reference to FIGS. 9 and 10. FIG. 9 is an exemplary block diagram functionally illustrating the configuration of the additive manufacturing apparatus 1 and the external computer 2 according to the third embodiment. As illustrated in FIG. 9, the control unit 14 according to the third embodiment includes an input-output interface (I/F) 81 besides the storage unit 61 and the manufacturing control unit 62.

The external computer 2 loads the units illustrated in FIG. 9 by the CPU 2a reading and executing computer programs stored in the ROM 2b or the storage 2d, for example. As illustrated in FIG. 9, the external computer 2 includes a storage unit 91, a condition changing unit 92, and an input-output I/F 93.

The storage unit 91 is included in the RAM 2c or the storage 2d, for example. The storage unit 91 stores therein various kinds of information including an NC program 91a and a plurality of functions 91b. The NC program 91a is an example of numerical control information. As with the NC program 61a in the storage unit 61, the NC program 91a includes information for manufacturing a plurality of layers 3b and the object 3 including the layers 3b.

The condition changing unit 92 can change the layer forming condition included in the NC program 91a. The input-output I/Fs 81 and 93 are used for communications between the additive manufacturing apparatus 1 and the external computer 2.

FIG. 10 is an exemplary flowchart of the procedure of changing the layer forming condition in the NC program 91a by the external computer 2 according to the third embodiment. As illustrated in FIG. 9, the NC program 91a is read from the storage unit 91 (S31). The NC program 91a is stored in the storage unit 91 in advance, for example. The external computer 2 may generate the NC program 91a from CAD data.

Subsequently, the condition changing unit 92 extracts information on the orientation of the nozzle 21 from the NC program 91a (S32). The condition changing unit 92 determines whether the nozzle 21 changes in orientation in additive manufacturing of the object 3 by the NC program 91a (S33).

In response to a change in the orientation of the nozzle 21 (Yes at S33), the condition changing unit 92 changes the layer forming condition in the NC program 91a in accordance with the change in the orientation of the nozzle 21 (S34). The condition changing unit 92 changes the layer forming condition using the functions 91b stored in the storage unit 91, for example. Thus, the condition changing unit 92 changes the layer forming condition in the NC program 91a on the basis of the information on the orientation of the nozzle 21. The condition changing unit 92 outputs the NC program 91a containing the changed layer forming condition as an updated NC program 91a (S35).

The external computer 2 inputs the updated NC program 91a to the additive manufacturing apparatus 1 via the input-output I/Fs 81 and 93. The NC program 91a is stored in the storage unit 61 as the NC program 61a. The manufacturing control unit 62 performs additive manufacturing based on the NC program 61a.

If the orientation of the nozzle 21 does not change (No at S33), the layer forming condition is not changed. The external computer 2 inputs the NC program 91a (NC program 61a) to the additive manufacturing apparatus 1. The manufacturing control unit 62 performs additive manufacturing based on the NC program 61a.

Changing the layer forming condition in the NC program 91a by the condition changing unit 92 is carried out by CAD/CAM software that can generate and edit the NC program 91a, for example. Changing the layer forming condition is not limited to this example and may be carried out by software other than the CAD/CAM software. If the NC program 91a is generated by general-purpose CAD/CAM software that does not support changing the layer forming condition, the layer forming condition can be changed.

In the additive manufacturing apparatus 1 and the external computer 2 according to the third embodiment, the external computer 2 extracts the information on the orientation of the nozzle 21 d from the NC program 91a for forming the layers 3b. According to the information on the orientation of the nozzle 21, the external computer 2 changes the layer forming condition in the NC program 91a. Thereby, the external computer 2 can determine to change the layer forming condition before the orientation of the nozzle 21 is actually changed. Under the changed layer forming condition, the nozzle 21 can form the layers 3b more accurately. Consequently, the additive manufacturing apparatus 1 can additively manufacture the object 3 having a shape closer to a desired shape. The additive manufacturing apparatus 1 including the nozzle 21 may not be adaptable to changing the layer forming condition or the NC program 91a. Also in this case, the additive manufacturing apparatus 1 can additively manufacture the object 3 having a shape closer to the desired shape by the NC program 91a containing the layer forming condition changed by the external computer 2.

The external computer 2 according to the third embodiment collectively changes the layer forming condition in the NC program 91a. In a modification, the additive manufacturing apparatus 1 according to the first or the second embodiment may collectively change the layer forming condition in the NC program 61a and perform additive manufacturing based on the updated NC program 61a. In this case, changing the layer forming condition in the NC program 91a by the condition changing unit 92 illustrated in FIG. 10 is replaced by changing the layer forming condition in the NC program 61a by the condition changing unit 66.

The computer program executed by the additive manufacturing apparatus 1 and the external computer 2 according to the embodiments described above is recorded and provided in a computer-readable recording medium, such as a compact disc read only memory (CD-ROM), a flexible disk (FD), a compact disc recordable (CD-R), and a digital versatile disc (DVD), as an installable or executable file.

The computer program executed by the additive manufacturing apparatus 1 and the external computer 2 according to the embodiments above may be stored in a computer connected to a network, such as the Internet, and provided by being downloaded via the network. Furthermore, the computer program executed by the additive manufacturing apparatus 1 and the external computer 2 according to the embodiments above may be provided or distributed via a network, such as the Internet.

The computer program according to the embodiments above may be embedded and provided in a ROM, for example.

The computer program executed by the additive manufacturing apparatus 1 and the external computer 2 according to the embodiments above has a module configuration including the units described above (the storage unit 61, the manufacturing control unit 62, the shape comparing unit 63, the layer number comparing unit 64, the angle acquiring unit 65, the condition changing unit 66, the input-output I/F 81, the storage unit 91, the condition changing unit 92, and the input-output I/F 93). In actual hardware, the CPU (processor) reads and executes the computer program from the storage medium described above to load the units on the main memory. As a result, the units described above are generated on the main memory

The embodiments described above can change the layer forming condition in detail. By checking the effects of changing the manufacturing condition by simulations, for example, the embodiments can effectively change the layer forming condition.

According to at least one of the first to third embodiments, the manufacturing unit can change the orientation of the nozzle. Typically, if the nozzle changes in orientation and inclines at a larger angle with respect to the normal direction of the support surface to eject the powder, the layers will be formed in decreased thickness per unit time in the normal direction of the support surface. To address this, the control unit according to the embodiments can change the layer forming condition for the nozzle in accordance with the change in the orientation of the nozzle. As a result, the control unit can change the layer forming condition for the nozzle such that the nozzle forms the layers of substantially uniform thickness in the normal direction of the support surface, for example. Consequently, the additive manufacturing apparatus can additively manufacture the object having a shape closer to a desired shape.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An additive manufacturing apparatus comprising:
a support surface that supports an object;
a manufacturing unit comprising a nozzle being changeable in orientation, the nozzle configured to move relative to the support surface, eject powder, and output an energy ray to melt or sinter the powder, thereby forming a layer of the object; and
a control unit that changes a layer forming condition for the nozzle in accordance with a change in the orientation of the nozzle.

2. The additive manufacturing apparatus according to claim 1, wherein
the layer forming condition includes at least one of movement speed of the nozzle with respect to the support surface, an amount of the powder ejected from the nozzle per unit time, output of the energy ray, a diameter of a focal point of the energy ray, and a position of the nozzle relative to the support surface.

3. The additive manufacturing apparatus according to claim 1, wherein
the control unit changes, in response to an increase in an inclination angle of the orientation of the nozzle with respect to a normal direction of the support surface, the layer forming condition such that the nozzle forms the layer of an increased thickness in the normal direction of the support surface from a thickness before changing the layer forming condition.

4. The additive manufacturing apparatus according to claim 1, wherein
the control unit changes the layer forming condition in accordance with the number of layers formed.

5. The additive manufacturing apparatus according to claim 1, further comprising:
a measuring unit configured to measure a shape of the layer, wherein
the control unit changes the layer forming condition on the basis of a result of measurement by the measuring unit.

6. An additive manufacturing method comprising:
moving a nozzle relative to a support surface, ejecting powder from the nozzle, and outputting an energy ray from the nozzle to melt or sinter the powder, thereby forming a layer of the object, the object that is supported by the support surface;
changing an orientation of the nozzle; and
changing a layer forming condition for the nozzle in accordance with a change in the orientation of the nozzle.

7. The additive manufacturing method according to claim 6, wherein
the layer forming condition includes at least one of movement speed of the nozzle with respect to the support surface, an amount of the powder ejected from the nozzle per unit time, output of the energy ray, a diameter of a focal point of the energy ray, and a position of the nozzle relative to the support surface.

8. The additive manufacturing method according to claim 6, wherein
the condition changing comprises changing, in response to an increase in an inclination angle of the orientation of the nozzle with respect to a normal direction of the support surface, the layer forming condition such that the nozzle forms the layer of an increased thickness in the normal direction of the support surface from a thickness before changing the layer forming condition.

9. The additive manufacturing method according to claim 6, further comprising
changing the layer forming condition in accordance with the number of layers formed.

10. The additive manufacturing method according to claim 6, further comprising:
measuring a shape of the layer; and
changing the layer forming condition on the basis of a result of measurement of the shape of the layer.

11. The additive manufacturing method according to claim 6, further comprising:
detecting the change in the orientation of the nozzle, wherein
the condition changing comprises changing the layer forming condition on the basis of a result of detection of the change in the orientation of the nozzle.

12. The additive manufacturing method according to claim 6, further comprising:
extracting information on the orientation of the nozzle from numerical control information for forming the layer, wherein
the condition changing comprises changing the layer forming condition on the basis of the information on the orientation of the nozzle.

13. The additive manufacturing method according to claim 6, further comprising:
extracting information on the orientation of the nozzle from numerical control information for forming the layer, wherein
the condition changing comprises changing the layer forming condition in the numerical control information on the basis of the information on the orientation of the nozzle.

14. A computer program product including programmed instructions embodied in and stored on a non-transitory computer readable medium, wherein the instructions, when executed by a computer, cause the computer to perform:
changing a layer forming condition for a nozzle in accordance with a change in orientation of the nozzle, the nozzle that is changeable in orientation and moves relative to a support surface that supports an object, ejects powder, and outputs an energy ray to melt or sinter the powder, thereby forming a layer of the object.

15. The computer program product according to claim 14, wherein the instructions cause the computer to further perform:
detecting the change in the orientation of the nozzle, wherein
the changing comprises changing the layer forming condition on the basis of a result of detection of the change in the orientation of the nozzle.

16. The computer program product according to claim 14, wherein the instructions cause the computer to further perform:
extracting information on the orientation of the nozzle from numerical control information for forming the layer, wherein
the changing comprises changing the layer forming condition on the basis of the information on the orientation of the nozzle.

17. The computer program product according to claim 14, wherein the instructions cause the computer to further perform:
extracting information on the orientation of the nozzle from numerical control information for forming the layer, wherein
the changing comprises changing the layer forming condition in the numerical control information on the basis of the information on the orientation of the nozzle.
